(19) United States
(12) Patent Application Publication
(10) Pub. No.: US 2011/0005694 A1
(43) Pub. Date: Jan. 13, 2011

(54) Adjustable Spring Assist for Window Coverings and Awnings

(76) Inventor: PHILIP NG, THORNHILL (CA)

Correspondence Address: ELIAS BORGES, 56 Aberfoyle Crescent, Suite 840, Canada, ON, M8X2W4, CA

(21) Appl. No.: 12/498,433

(22) Filed: Jul. 7, 2009

(51) Int. Cl. E06B 9/68; E06B 9/60

(52) U.S. Cl. 160/311; 160/313; 160/315

(57) ABSTRACT

There is provided a spring assisted electric motor driven lifting mechanism for lifting and lowering a blind which permits the quick and easy matching of the spring assist pre-rotation to the torque output of the electric motor. The device includes an elongated cylinder coupled to the blind such that rotating the cylinder about its axis lifts and lowers the blind. Coupled to the elongated cylinder is an electric motor which is configured to rotate the elongated cylinder about its axis. A torsion spring is coupled to the cylinder for biasing the elongated cylinder to at least partially neutralize the weight of the blind. The torsion spring is in turn coupled to a spring preload adjuster which is configured to adjust the tension on the torsion spring by moving an adjustment member. The spring preload adjuster is further configured such that the adjustment member extends perpendicularly away from the axis of the elongated cylinder.

### FIELD OF THE INVENTION

The invention relates generally to adjustable spring assist mechanisms which are used in window coverings and awnings to partially neutralize the weight of the blind or awning.

### BACKGROUND OF THE INVENTION

Motorized blinds incorporate an electric motor to raise and lower the blind. These motorized blinds usually incorporate an elongated roller tube upon which either the blind (in the case of a roller blind) or the support chords (in the case of a roman, pleated, cellular or other blind) are wound. The electric motor is placed within the roller tube and, upon activation, causes the roller tube to rotate about its axis, either lifting or lowering the blind. The electric motor must be sufficiently large to apply sufficient torque to the roller tube to overcome the weight of the blind when the blind is fully lowered (in the case of a roller blind) or when the blind is fully raised (in the case of a roman, pleated or cellular blind). For a standard sized blind typically used for residential applications, a relatively small electric motor is sufficient. In the case of a large blind which is several meters in length, then a much larger electric motor is required since the blind would be correspondingly much heavier. Larger electric motors have several drawbacks. Firstly, they are generally larger and therefore require larger roller tubes. Also, they tend to be more expensive, and most significantly, they require more electric energy to operate. Since large electric motors require more electric energy to operate, they tend to require higher voltage wiring, usually 110 v or 220 v. This means that installing these larger electric blinds generally requires a licensed electrician.

Spring assisted roller blinds have been in operation for many years. These roller blinds use an elongated torsion spring to partially or completely neutralize the weight of the blind, making the blinds easier to open and close. The tension of the torsion spring in the spring assist is preset so that the spring assist neutralizes the weight of the blind. The tension of the torsion spring is preset by pre-rotating the spring assist through several revolutions before the blind is fully assembled and installed. Combining an electric motor with a spring assist is not practical because it is very difficult to match the required pre-rotation of the spring assist when the spring assist is coupled to both the roller tube and the electric motor. If not enough pre-rotation is applied to the spring assist, then the electric motor will either not be able to operate the blind or the motor will draw too much current and potentially burn out. However, if too much pre-rotation is applied to the spring assist, then the electric motor will not be able to fully lower a raised roller blind, or in the case of roman, pleated or cellular blinds, the electric motor will not be able to fully raise the blind. As a result, correctly matching the pre-rotation of the spring assist to the electric motor is vital. Unfortunately, the only way to correctly preset the pre-rotation of the spring assist to match with the electric motor would be to repeatedly preset the spring assist pre-rotation, then assemble and mount the blind, then test the pre-rotation of the spring assist, then take down the blind again, disassemble it and reset the pre-rotation of the spring assist. This operation would have to be repeated over and over again until the correct pre-rotation for the spring assist is found. Furthermore, over time the tension of the torsion spring in the spring assist would change, requiring removal, disassembly and then further adjustment followed by further testing, removal and adjustment. As a result, spring assisted electrically driven blinds have not been available in the market. An improved spring assist mechanism in combination with an electric motor which makes it possible to accurately, precisely and quickly match the pre-rotation of the spring assist to the electric motor is therefore desired.

### SUMMARY OF THE INVENTION

In accordance with one aspect of the present invention, there is provided a spring assisted lifting mechanism for lifting and lowering a blind which permits the quick and easy matching of the spring assist pre-rotation to the drive mechanism for lifting and lowering the blind. The device includes an elongated cylinder coupled to the blind such that rotating the cylinder about its axis lifts and lowers the blind. Coupled to the elongated cylinder is a cylinder drive which is configured to rotate the elongated cylinder about its axis. A torsion spring is coupled to the cylinder for biasing the elongated cylinder to at least partially neutralize the weight of the blind. The torsion spring is in turn coupled to a spring preload adjuster which is configured to adjust the tension on the torsion spring by moving an adjustment member. The spring preload adjuster is further configured such that the adjustment member extends perpendicularly away from the axis of the elongated cylinder.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a long sectional view of a roller blind incorporating a motorized and spring assisted blind lifting device made in accordance with the present invention.

FIG. 2 is a blown up portion of FIG. 1 showing the spring assist portion of the present invention.

FIG. 3 is a cross sectional view of the spring preload adjustment portion of the present invention.

FIG. 4 is a front view of a portion of a roller blind incorporating a motorized and spring assisted blind lifting device made in accordance with the present invention and showing details of the tension adjustment portion of the present invention.

FIG. 5 is a long sectional view of a roller blind incorporating a hand operated blind lifting drive and spring assist made in accordance with the present invention.

FIG. 6 is an exploded view of the slip clutch portion of the roller blind shown in FIG. 1.

FIG. 7 is a perspective view of a preload rotation counter for use with the spring assist mechanism made in accordance with the present invention.

FIG. 8 is a top view of the preload rotation counter shown in FIG. 7.

FIG. 9 is a side view of the preload rotation counter shown in FIG. 8.

FIG. 10 is a front view, partly in cross section, of the preload rotation counter shown in FIG. 8 being used in combination with spring preload adjustment portion of the present invention.

In the drawings like characters of reference indicate corresponding parts in the different figures.

### DETAILED DESCRIPTION OF THE INVENTION

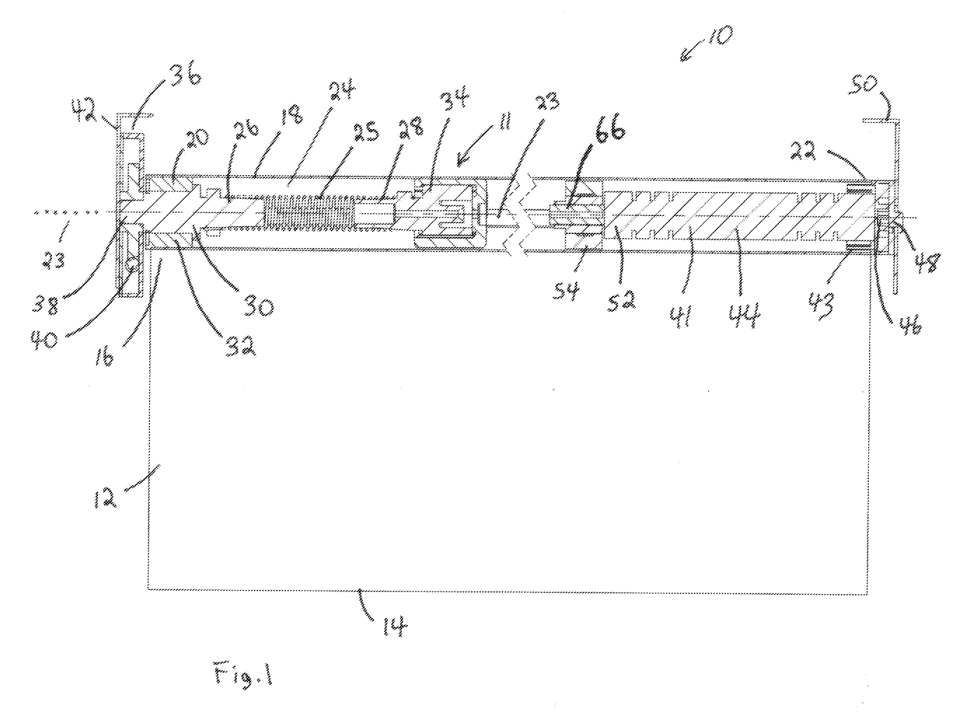

Referring firstly to FIG. 1, a blind incorporating an adjustable spring assisted blind lifting device made in accordance with the present invention is shown generally as item 10 and includes blind 12 having lower end 14 and upper end 16. Upper end 16 is attached to drive mechanism 11 which includes elongated cylinder 18 having opposite ends 20 and 22 and axis 23. Elongated cylinder 18 is preferably an elongated tube of the type generally used to construct roller blinds (often called roller tubes). Attached to end 20 of elongated cylinder (roller tube) 18 is spring assist mechanism 24 which consists of an elongated torsion spring 25 having opposite ends 26 and 28. Spring assist mechanism 24 is configured to apply a biasing torque to elongated cylinder (roller tube) 18 to at least partially neutralize the weight of blind 12. End 26 of torsion spring 26 is attached to coupling 30 which is in turn rotatably coupled to yoke 32 which is coupled to end 20 of roller tube 18. Opposite end 28 of torsion spring 25 is attached to coupling 34 which is attached to roller tube 18. Couplings 30 and 34 are dimensioned and configured such that torsion spring 25 is coaxially aligned with axis 23 or roller tube 18. As roller tube 18 is rotated about axis 23, blind 12 is lowered or lifted (depending on the direction of rotation) and torsion spring 25 is loaded or unloaded, respectively. Torsion spring 25 acts to partially neutralize the weight of blind 12. As blind 12 is lowered, roller tube 18 rotates and torsion spring 25 is loaded. Ideally, tension spring 25 is preloaded (i.e. pre-tensioned) sufficiently such that the torsion spring counteracts the torsion applied by blind 12 when the blind is fully lowered. Torsion spring 25 is coupled to spring preload adjuster 36 via end 38 of coupling 30. Spring preload adjuster 36 has an adjustment member 40 which when moved (i.e. rotated) changes the tension in tension spring 25 by rotating the tension spring about axis 23. Hence, torsion spring 25 can be pre-tensioned by simply rotating adjustment member (worm gear) 40. Spring preload adjuster 36 is attached to bracket member 42 which is in turn fixed to a wall or window frame (not shown).

Drive mechanism 41 is coupled to the opposite end 22 of roller tube 18 via yoke 43. Drive mechanism 41 may comprise any type of electrically operated or hand operated drive configured to raise or lower blind 12 by rotating roller tube 18. Drive mechanism 41 is configured to apply a drive torque to roller tube 18 which, when combined with the biasing torque generated by spring assist 24, is sufficient to raise and lower blind 12. In the embodiment of the present invention shown in FIG. 1, drive mechanism 41 consists of an electric motor 44 having an end 46 which passes through yoke 43 and which is coupled to coupling 48. Yoke 43 is mounted to roller tube 18 and is rotatably mounted to electric motor 44 to permit the roller tube to rotate relative to the electric motor. Coupling 48 is rigidly coupled to bracket 50 which is in turn fixed to a wall or window frame (not shown). Electric motor 44 has shaft 66 which is coupled to slip clutch 54, which is in turn coupled to roller tube 18. Electric motor 44 is coaxially aligned with roller tube 18 and activation of electric motor 44 causes shaft 66 to rotate which in turn causes roller tube 18 to rotate about axis 23. When electric motor 44 is de-activated, shaft 66 does not rotate, thereby keeping roller tube 18 from rotating. As explained further below, slip clutch 54 permits roller tube 18 to rotate relative to shaft 66 when sufficient downward force is applied to blind 12.

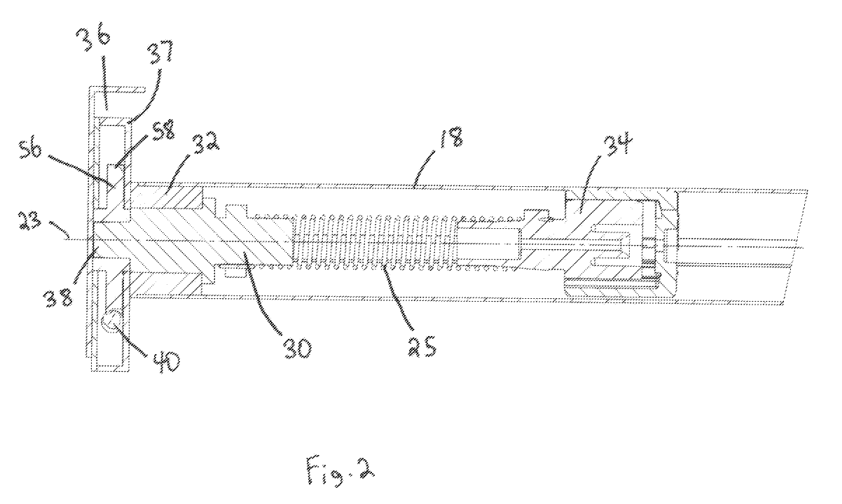

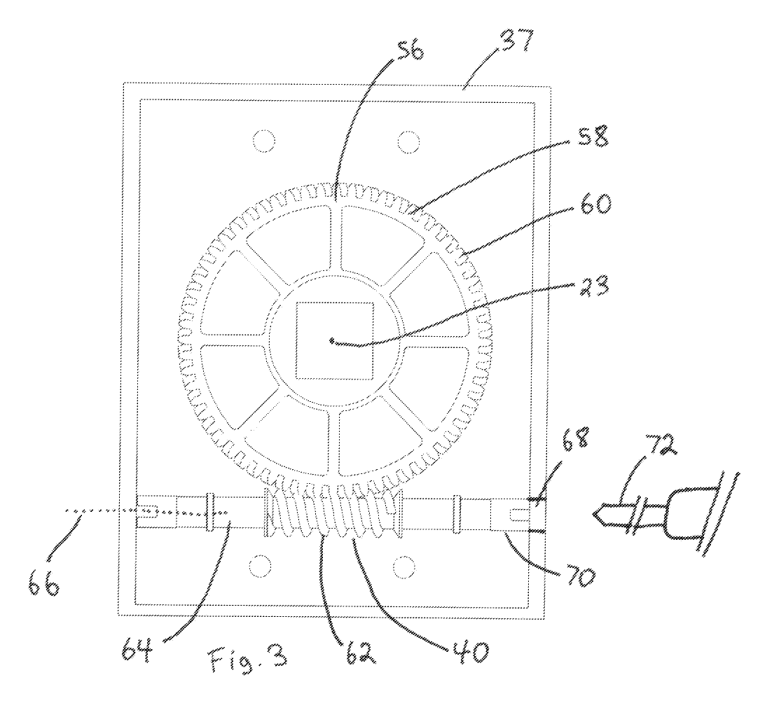

Referring now to FIG. 2, spring preload adjuster 36 consists of a housing 37 which contains a circular gear 56 which is coupled to and coaxially aligned with end 38 of coupling 30. Rotation of circular gear 56 causes a corresponding rotation in torsion spring 25, which in turn either increases or decreases the tension on the spring depending on which direction the circular gear is rotated. Adjustment member 40 is preferably a worm gear which is rotatably mounted within housing 37 and oriented perpendicularly to circular gear 56 and axis 23. Circular gear 56 has a peripheral edge 58 with teeth which are configured to intermesh with worm gear (adjustment member) 40 such that rotation of the worm gear causes a corresponding rotation in circular gear 56. As best seen in FIG. 3 adjustment member 40 consists of an elongated shaft having worm gear portion 62 which is configured to intermesh with teeth 60 of circular gear 58. Adjustment member 40 has axis 66 which is perpendicular to axis 23. End 70 of adjustment member 40 is positioned immediately adjacent opening 68 in housing 37. End 70 is also configured such that it can be engaged by screw driver 72 (or by an allen key or similar tool). Opening 68 is dimensioned sufficiently to permit the end of screw drive 72 to engage end 70 of adjustment member 40 in order to allow the user (not shown) to rotate adjustment member sufficiently to rotate circular gear 56 and in turn adjust the tension of the torsion spring of the spring assist (see item 25 of FIG. 2).

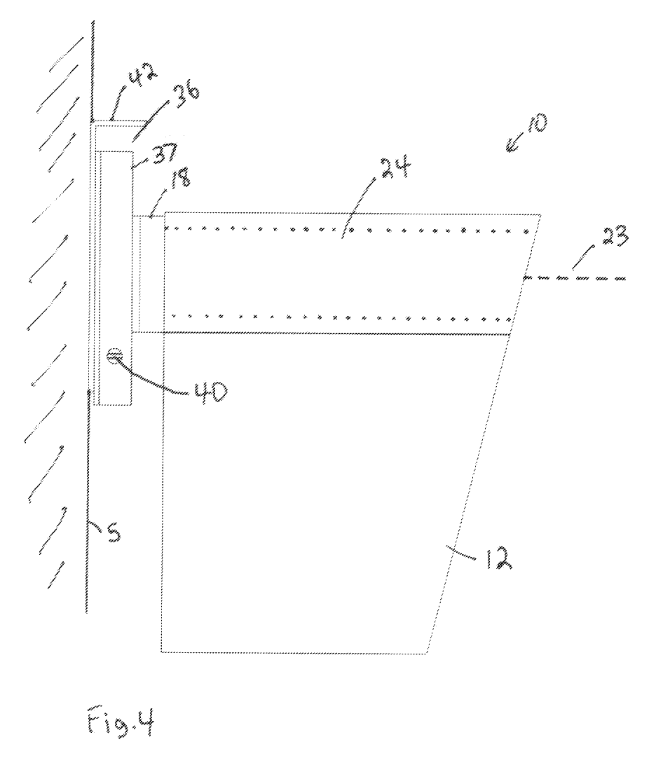

Referring now to FIG. 4, orienting adjustment member 40 such that it extends perpendicular to axis 23 of roller tube 18 makes the drive mechanism of the present invention practical. By orienting adjustment member 40 perpendicular to axis 23, the spring assist mechanism 24 can be pre-tensioned after blind 10 has been installed to wall 5. It will be appreciated that if adjustment member 40 was coaxial to axis 23, it would be impossible to adjust the pre-tension of the spring assist while the blind was mounted to wall 5 since the adjustment member would not be accessible. The present arrangement makes it possible to mount blind 10 to wall 5 (or immediately adjacent wall 5) and then adjust spring assist 24 to neutralize the weight of blind 12. Since the blind is already mounted, precisely adjusting the spring assist to completely neutralize the weight of blind 12 is much easier. This removes the guess work associated with pre-tensioning the spring assist and speeds up the installation of the blind.

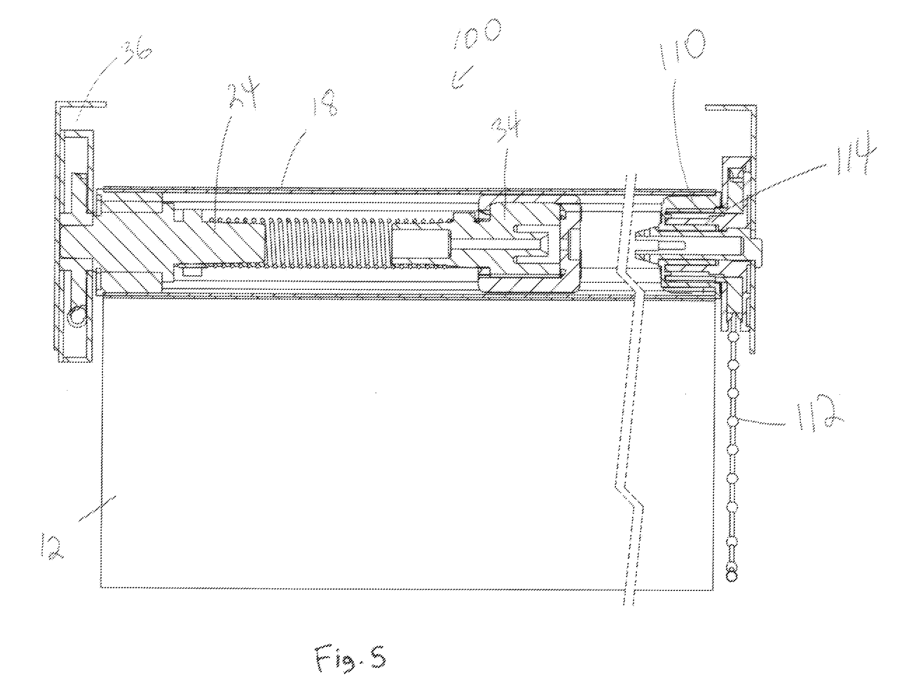

Referring now to FIG. 5, the adjustable spring assist mechanism of the present invention can be coupled for use with a hand operated drive mechanism for lifting and lowering the blind. Roller blind 100 is virtually identical to the previously discussed roller blind and includes a roller tube 18 coupled to the spring assist mechanism 24 as discussed in the previous example. Blind 12 is coupled to roller tube 18. Drive mechanism 110 consists of a roller clutch 114 which is coupled to roller tube 18 and to chain 112. Pulling on chain 112 causes roller clutch 114 to apply a torque to roller tube 18 which, with the assistance of the torque applied by spring assist 24, causes roller tube 18 to rotate in response and blind 12 to either lift or lower depending on how the chain is pulled. Roller clutch 114 is a standard roller clutch as commonly available in the market. Spring preload adjuster 36 is coupled to spring assist 24 as in the previous roller blind example. Roller clutch 114 may incorporate a slip clutch (not shown) there in to permit a user (not shown) to lower blind 12 by simply pulling on the blind with a force greater than the torque applied by spring assist 24.

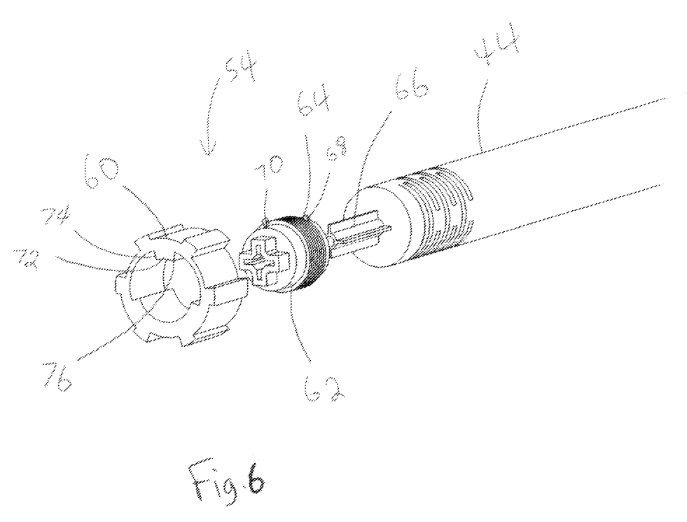

Referring now to FIG. 6, slip clutch 54 consists of a hub member 62, slip spring 64 mounted onto hub member 62, and coupling 60. Hub member 62 is configured to fit onto shaft 66 which extends from electric motor 44 so that the hub and shaft move together. Slip spring 64 has ends 68 and 70 which are spaced apart sufficiently such that protrusion 72 of coupling 60 fits between ends 68 and 70 when coupling 60 is coaxially mounted over hub 62. Slip spring 64 is configured such that when hub 62 is rotated relative to coupling 60, one of ends 68 and 70 of the slip spring are engaged by ends 76 and 74 of protrusion 72, respectively, causing slip spring 64 to constrict more tightly onto hub 62. Slip spring 64 and hub 62 are further configured such that when coupling 60 is rotated relative to hub 62 with a torsion force (slip torque) exceeding a predetermined level, slip spring 64 will rotate along with coupling 60 relative to hub 62 without damaging hub 62. As mentioned above with reference to FIG. 1, electric motor 44 is configured to apply a motor torque to roller tube 18 and spring assist 24 is configured to apply a biasing torque to roller tube 18 sufficient to rotate the roller tube and lift blind 12. Slip spring 64 and hub 62 are configured such that the predetermined level of the slip torque exceeds the combined motor and biasing torques to permit the user, not shown, to lower blind 12 simply by pulling down on the blind.

Referring back to FIG. 2, it will be appreciated that accurately adjusting the biasing torque applied by the spring assist mechanism 36 is important to ensure that the spring assist mechanism neutralizes the weight of the blind 12. As mentioned above, in order to ensure that the spring assist mechanism 36 neutralizes the weight of blind 12, the spring assist mechanism must be preloaded by pre-rotating the elongated torsion (biasing) spring 25 through one or more rotations via several rotations of worm gear 40. However, accurately pre-rotating the biasing spring may involve guess work, particularly if there is a large ration between worm gear 40 and circular gear 56. Hence, if the user wished to rotate elongated biasing spring 25 by 4 rotations, and if the ratio between circular gear 56 and worm gear 40 was 9:1, then the user would have to rotate the screw by 36 rotations. Rotating worm gear 40 36 times is trivial if an electric screwdriver or drill is used; however, keeping track of the number of rotations through which worm gear 40 is rotated may be quite difficult. Therefore, precisely adjusting the pre-rotation of elongated biasing spring 25 to a specific number of pre-rotations may be difficult.

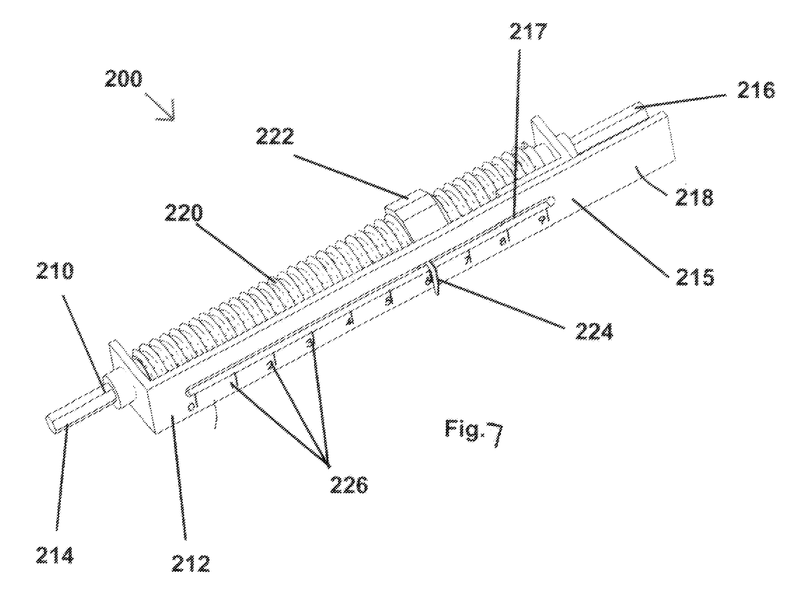

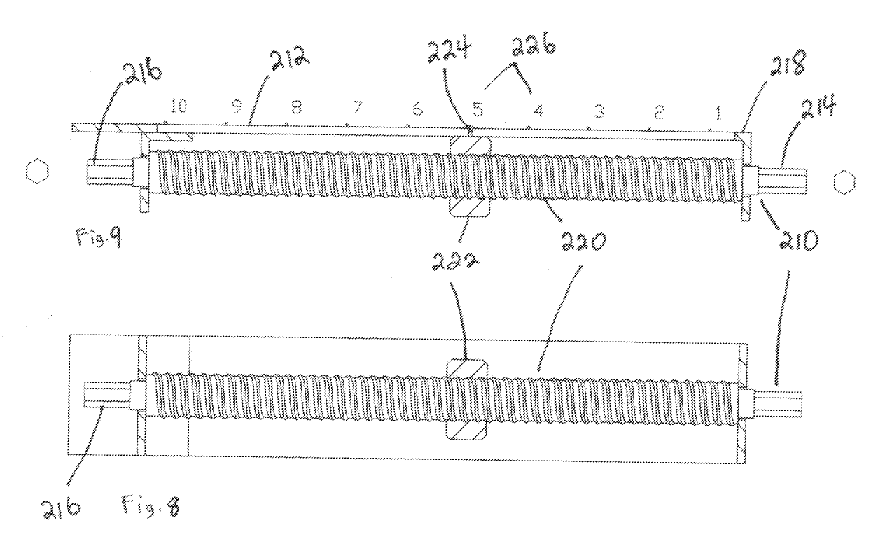

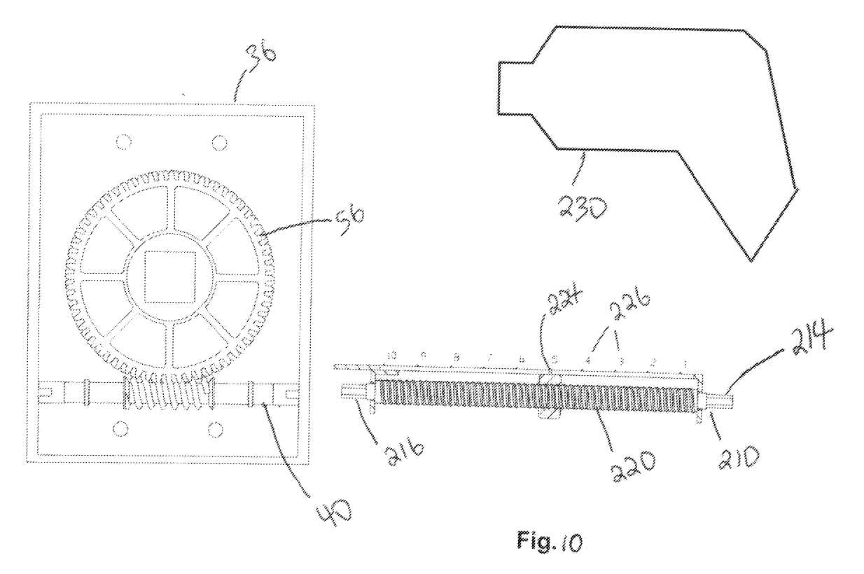

Referring now to FIGS. 7, 8 and 9, a preload rotation counter, shown generally as item 200, may be used to help precisely adjust the tension (i.e. pre-rotation) of elongated torsion spring 25 (see FIG. 1). Preload rotation counter 200 consists of an elongated shaft 210 rotatably mounted to housing 212 and having opposite ends 214 and 216. Elongated shaft 210 has threaded portion 220 with nut 222 threaded thereon. Housing 212 has protruding end 218 and face 215 with elongated slot 217 and indicia 226 formed thereon. But 222 is coupled to indicator 224 which projects through slot 217. Nut 222 is configured such that as shaft 210 is rotated, nut 222 moves along threaded portion 220 and indicator 224 moves along face 215.

Referring now to FIG. 10, end 214 of shaft 210 is configured to couple to an electric screw driver or drill 230 and end 216 is configured to couple to worm gear 40 of spring preload adjuster 36. Drill 230, when activated, will cause the rapid rotation of shaft 210 of preload rotation counter 200, which in turn will cause the rapid rotation of worm gear 40 and a corresponding slower rotation of circular gear 56. As mentioned above, rotation of circular gear 56 causes a corresponding rotation in the elongated torsion spring 25 (see FIG. 2) and therefore preloads the elongated torsion spring with tension. Also, as shaft 210 is rotated, indicator 224 moves. The treading of threaded portion 220 and the spacing of indicia 226 are configured such as shaft 210 is rotated through sufficient turns to cause circular gear to 56 to rotate through one full rotation, indicator 224 moves one full indicator number. Hence, the number of rotations of circular gear 56 is indicated by the indicia on preload rotation counter 200. This provides a convenient and efficient means for accurately preloading the elongated torsion spring 25 (see FIG. 2) by a set number of pre-rotations. Hence, if 5 pre-rotations are required, the user need only apply the drill to rotate shaft 210 until the indicia 226 reads 5. This takes the guess work out of pre-loading the spring biasing mechanism and decreases the likelihood that the spring biasing mechanism will be either pre-loaded too much or not pre-loaded enough to neutralize the weight of the blind. This also permits the rapid installation of several blinds. The first installed blind will require some level of testing before the correct pre-rotation is found to fully neutralize the weight of the blind. Once the exact number of pre-rotations is found, however, the remaining blinds (assuming they are of the same size and type) can simply be pre-rotated to the exact level as the first installed blind. Minor variations to the pre-rotation can then be done by hand.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A lifting mechanism for lifting and lowering a blind having a weight, the lifting device comprising:
a) an elongated cylinder having an axis, said elongated cylinder being coupled to the blind such that rotating the cylinder about the axis lifts and lowers the blind;
b) a cylinder drive coupled to the elongated cylinder and configured to rotate the elongated cylinder about the axis;
c) a torsion spring coupled to the elongated cylinder for biasing the elongated cylinder to at least partially neutralize the weight of the blind, said torsion spring coupled to a spring preload adjuster for adjusting tension on the torsion spring by moving an adjustment member, the adjustment member extending perpendicularly away from the axis of the cylinder.

2. The lifting mechanism of claim 1 wherein the torsion spring is coaxially mounted within the elongated cylinder and wherein the torsion spring has opposite first and second ends, the first end of the torsion spring being coupled to the elongated cylinder and the second end of the spring being coupled to a cam coaxially mounted to the spring, the cam being in turn coupled to the adjustment member, the adjustment member and cam being configured such that moving the adjustment member causes the cam and torsion spring to coaxially rotate together.

3. The lifting mechanism of claim 2 wherein the cam is coupled to a circular gear rotatably mounted within a housing, the circular gear being coupled to the cam such that rotating the circular gear causes rotation of the cam, the adjustment member comprising a worm gear rotatably mounted within the housing, the worm gear being oriented perpendicular to and intermeshed with the circular gear, the worm gear having an end immediately adjacent an opening in the housing such that the worm gear can be rotated by rotating the end through the opening, the opening oriented perpendicular to the axis of the elongated cylinder, the worm gear and circular gear being configured such that rotating the worm gear causes rotation of the circular gear.

4. The lifting mechanism of claim 3 wherein the worm gear and the circular gear are configured such that rotating the worm gear causes a corresponding rotation of the circular gear while rotating the circular gear does not cause a corresponding rotation of the worm gear.

5. The lifting mechanism of claim 1 wherein the spring preload adjuster comprises a circular gear rotatably mounted within a housing, the circular gear being oriented parallel to the axis of the elongated cylinder, the circular gear being coupled to the torsion spring such that rotation of the circular gear causes a corresponding rotation in the torsion spring thereby adjusting the tension in the torsion spring, the adjust member comprising a worm gear rotatably mounted to the housing and intermeshed with the circular gear, the worm gear being oriented perpendicular to the circular gear, the worm gear and circular gear being configured such that rotating the worm gear causes a corresponding rotation of the circular gear.

6. The lifting mechanism of claim 5 wherein the worm gear and the circular gear are configured such that rotating the worm gear causes a corresponding rotation of the circular gear while rotating the circular gear does not cause a corresponding rotation of the worm gear.

7. The lifting mechanism of claim 6 wherein the worm gear has an end positioned adjacent an opening in the housing, the opening in the housing being dimensioned sufficiently to permit the rotation of the end of the worm gear from outside the housing.

8. The lifting mechanism of claim 7 wherein the end of the worm gear is configured to couple to an end of a screw driver.

9. The lifting mechanism of claim 1 wherein the cylinder drive comprises an electric motor.

10. The lifting mechanism of claim 9 wherein the electric motor is configured to apply a motor torque to the elongated cylinder and wherein the torsion spring is configured to apply a biasing torque to the elongated cylinder to at least partially neutralize the weight of the blind, the electric motor and torsion spring being configured such that the combined motor torque and biasing torque being sufficient to raise and lower the blind, the electric motor being coupled to the elongated cylinder by a slip clutch, the slip clutch being configured to permit the blind to be lowered by pulling the blind down with a force greater than the combined biasing torque and motor torque.

11. A roller blind comprising:
a) a roller tube having an axis, said elongated cylinder being coupled to a blind such that rotating the cylinder about the axis lifts and lowers the blind;
b) a drive coupled to the elongated cylinder configured to rotate the elongated cylinder about the axis;
c) a torsion spring coupled to the elongated cylinder for partly neutralizing the weight of the blind weight, said torsion spring having opposite first and second ends, the first end being coupled to the elongated cylinder;
d) a circular gear rotatably mounted in a housing, the circular gear being coupled to the second end of the torsion spring such that rotating the circular gear causes a corresponding rotation in the tension spring and a corresponding adjustment in the tension spring's tension;
e) a worm gear rotatably mounted in the housing and oriented to mesh perpendicularly with the circular gear, the worm gear and circular gear being configured such that several rotations of the worm gear causes a single corresponding rotation in the circular gear, and
f) the worm gear having an end positioned perpendicularly away from the axis of the roller tube, the housing being configured such that the end of the worm gear can be accessed to cause the worm gear to rotate.

12. The lifting mechanism of claim 11 wherein the end of the worm gear is positioned adjacent an opening in the housing, the opening in the housing being dimensioned sufficiently to permit the rotation of the end of the worm gear from outside the housing.

13. The lifting mechanism of claim 12 wherein the end of the worm gear is configured to couple to an end of a screw driver.

14. The lifting mechanism of claim 11 wherein the cylinder drive comprises an electric motor.

15. The lifting mechanism of claim 14 wherein the electric motor is configured to apply a motor torque to the elongated cylinder and wherein the torsion spring is configured to apply a biasing torque to the elongated cylinder to at least partially neutralize the weight of the blind, the electric motor and torsion spring being configured such that the combined motor torque and biasing torque being sufficient to rotate the elongated cylinder to raise and lower the blind, the electric motor being coupled to the elongated cylinder by a slip clutch, the slip clutch being configured to permit the blind to be lowered by pulling the blind down with a force greater than the combined biasing torque and motor torque.

16. The roller blind of claim 11 further comprising a preload rotation counter for precisely measuring a preload rotation of the torsion spring, the preload rotation counter comprising an elongated shaft having a first end configured to couple to the end of the worm gear and a second end configured to couple to an electric drive, the elongated shaft being rotatably mounted to a counter housing having a face thereon, a threaded portion being formed on the elongated shaft between the first and second ends of the elongated shaft with a nut being threaded thereon, the nut being configured such that the nut moves along the housing as the elongated shaft is rotated, an indicator being coupled to the nut and housing such that indicator moves along the face of the housing as the nut moves along the shaft, the face having a plurality of spaced apart indicia formed thereon to measure the movement of the indicator, the treaded portion and the indicia being configured such that the movement of the indicator corresponds to the rotation of the circular gear.
